(19) United States
(12) Patent Application Publication
(10) Pub. No.: US 2025/0306581 A1
(43) Pub. Date: Oct. 2, 2025

(54) DETECTION DEVICE OF EQUIPMENT ABNORMALITY AND DIAGNOSTIC SYSTEM INCLUDING THE SAME

(71) Applicant: Samsung Electronics Co., Ltd., Suwon-si (KR)

(72) Inventors: Min Jae CHOI, Suwon-si (KR); Wan Wook KI, Suwon-si (KR); Young Hoon KIM, Suwon-si (KR); Jae Yong PARK, Suwon-si (KR); Ji Soo PARK, Suwon-si (KR); Ji Yeon PARK, Suwon-si (KR); Yong Jun LEE, Suwon-si (KR)

(21) Appl. No.: 18/950,663

(22) Filed: Nov. 18, 2024

(30) Foreign Application Priority Data
Mar. 29, 2024 (KR) 10-2024-0043170

(51) Int. Cl. G05B 23/02; H04W 84/18

(52) U.S. Cl. CPC G05B 23/0205; H04W 84/18

(57) ABSTRACT

Provided are an equipment abnormality detection device and equipment abnormality diagnostic system including a data collection device configured to collect operating status data from a plurality of sensors attached to equipment, and an equipment abnormality detection device configured to diagnose whether the equipment is abnormal based on the operating status data, wherein the equipment abnormality detection device is configured to select the equipment status from the collected operating status data, calculate similarity between the sensors from filtered sensor data of the selected equipment status, implement a sensor network on the basis of the similarity between the sensors, compare the sensor network of a first equipment status with the sensor network of a second equipment status to compare connection statuses for each sensor node, and check an influence of a sensor node having a maximum connection status difference value as a comparison result to diagnose an abnormality status of the equipment.

### CROSS-REFERENCE TO RELATED APPLICATION

This application claims priority under 35 U.S.C. § 119 from Korean Patent Application No. 10-2024-0043170, filed on Mar. 29, 2024, in the Korean Intellectual Property Office, and all the benefits accruing therefrom under 35 U.S.C. 119, the contents of which in its entirety are herein incorporated by reference.

### BACKGROUND

### 1. Technical Field

The technical idea of the present disclosure relates to an equipment diagnostic technique for determining whether there is an abnormality in the equipment, and particularly, to an equipment diagnostic technique for determining whether there is an abnormality in the equipment on the basis of a sensor network.

### 2. Description of the Related Art

In recent years, various data analysis techniques have been utilized to develop semiconductor process equipment and optimize processes for manufacturing target products. However, there are several concerns with existing equipment diagnostic techniques, and the typical concerns are as follows.

First, it is difficult to diagnose abnormality status of the equipment by directly quantifying time-series data acquired on a time domain. The equipment which is in charge of each process includes thousands to tens of thousands of sensors, and may measure pressure, temperature, flow rate, voltage, and the like of the equipment through the sensors.

When a PM (Preventive Maintenance) or a BM (Breakdown Maintenance) of the equipment occurs, equipment changes may affect the equipment status and performance. Alternatively, environmental information is newly changed at the stage of moving from test equipment to mass production equipment, but such a stage change may change the equipment status, and the equipment status may change due to certain modules, the aging of hardware components, unspecified failures or errors, in addition to planned equipment changes.

As complexity of the equipment increases, higher-level analytical techniques are required to predict changes in equipment statuses and identify the causes thereof. The number of modules and hardware components that make up the complex equipment increases, and as the resolution of the sensors included therein increases, it is required to analyze the degree of changes and relevance of each sensor together.

There have been various attempts to find equipment abnormality in the semiconductor domain. Statistical analysis, machine learning and the like have been applied to various problems, but they are insufficient to derive the causes of equipment statuses on the basis of changes in sensor data.

### SUMMARY

Aspects of the present disclosure provide an equipment abnormality detection device and a diagnostic system that realize a visualized sensor network on the basis of the correlation between sensor data of a plurality of sensors, and detect sensors with a large difference in connection status between the sensor networks, thereby diagnosing changes in the equipment status.

Aspects of the present disclosure also provide an equipment abnormality detection device and a diagnostic system thereof that derive equipment abnormality-inducing factors due to equipment changes or unpredictable failures by grasping the correlation between the sensors through comparison of connection statuses between sensor networks as equipment status changes.

However, aspects of the present disclosure are not restricted to the ones set forth herein. The above and other aspects of the present disclosure will become more apparent to one of ordinary skill in the art to which the present disclosure pertains by referencing the detailed description of the present disclosure given below.

According to an aspect of the present disclosure, there is provided an equipment abnormality diagnostic system comprising a data collection device configured to collect operating status data from a plurality of sensors attached to equipment, and an equipment abnormality detection device configured to diagnose whether the equipment is abnormal on the basis of the operating status data, wherein the detection device of equipment abnormality is further configured to select the equipment status from the collected operating status data, calculate similarity between the plurality of sensors from filtered sensor data of the selected equipment status, implement a sensor network on the basis of the similarity between the plurality of sensors, compare the sensor network of a first equipment status of the selected equipment statuses with the sensor network of a second equipment status of the selected equipment statuses to compare connection statuses for each sensor node, and check an influence of a sensor node having a maximum connection status difference value as a comparison result to diagnose an abnormality status of the equipment.

According to an aspect of the present disclosure, there is also provided an equipment abnormality diagnostic system comprising, a data collection device configured to collect operating status data from a plurality of sensors attached to equipment, and an equipment abnormality detection device configured to diagnose whether the equipment is abnormal on the basis of the operating status data, wherein the equipment abnormality detection device configured to pre-process the collected operating status data, filter the pre-processed operating status data for each equipment status, calculate a similarity between at least two sensors from the filtered operating status data, implement a sensor network on the plurality of sensors on the basis of the similarity, compare connection statuses between sensor networks corresponding to at least two equipment statuses, and diagnose an abnormality status of the equipment on the basis of the sensor nodes having different connection statuses.

According to an aspect of the present disclosure, there is also provided an equipment abnormality diagnostic system comprising, a data collection device configured to collect operating status data from a plurality of sensors attached to equipment, and an equipment abnormality detection device comprises a memory configured to store operating status data and a processor configured to detect an abnormality status of the equipment on the basis of the operating status data, wherein the processor is further configured to receive the operating status data from a plurality of sensors attached to the equipment, select an equipment status of the equipment, calculate similarity between at least two sensors from the operating status data for each equipment status, implement a sensor network for each equipment status on the basis of the similarity between the sensors, compare the sensor network of a first equipment status with the sensor network of a second equipment status to compare a connection status for each sensor node, and check a sensor node having a maximum connection status difference value as a comparison result to diagnose an abnormality status of the equipment.

It should be noted that the effects of the present disclosure are not limited to those described above, and other effects of the present disclosure will be apparent from the following description.

### BRIEF DESCRIPTION OF THE DRAWINGS

The above and other aspects and features of the present disclosure will become more apparent by describing in detail illustrative embodiments thereof with reference to the attached drawings, in which:

FIG. 1 is a block diagram schematically showing an equipment abnormality diagnostic system according to some example embodiments.

FIG. 2 is a flowchart for explaining an operating method of an equipment abnormality diagnostic system according to some example embodiments.

FIG. 3 is a diagram for explaining data changes for explaining a data pre-processing process of the equipment abnormality diagnostic system according to some example embodiments.

FIG. 4 is a histogram and a distribution graph for each time showing the distribution of sensor data.

FIG. 5 is a diagram for explaining conversion of a correlation matrix into an adjacency matrix according to some example embodiments.

FIG. 6 is a conceptual diagram for explaining generating of sensing data of sensors A, B, and C into an adjacency matrix and sensor network according to some example embodiments.

FIG. 7 is a conceptual diagram for explaining a sensor network between seven sensors according to some example embodiments.

FIG. 8 is a diagram for explaining differences in connection statuses for each node of the sensor network according to some example embodiments.

FIG. 9 is a diagram showing the influence of nodes with maximum connection status difference in the sensor network according to some example embodiments.

### DETAILED DESCRIPTION OF THE EMBODIMENTS

Like reference characters refer to like elements throughout. Although terms including ordinal numbers such as “first” or “second” as used herein may be used to describe various components, the aforementioned components should not be limited by the terms. The aforementioned terms may be used to distinguish one component from another component.

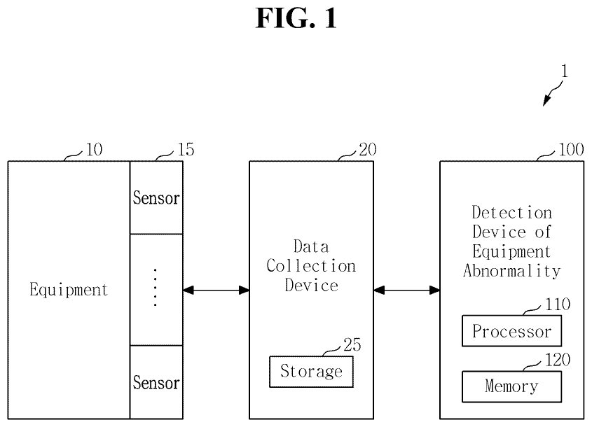

The description of the following embodiments should not be construed to limit the scope of rights, and the contents that may be easily deduced by a person skilled in the art should be construed as falling within the scope of rights of the embodiments. Hereinafter, a diagnostic system for diagnosing equipment abnormality status according to some embodiments of the present disclosure will be described below with reference to FIGS. 1 to 9.

FIG. 1 is a block diagram schematically showing an equipment abnormality diagnostic system according to some example embodiments.

Referring to FIG. 1, an equipment abnormality diagnostic system 1 according to some embodiments includes equipment 10 to be diagnosed, a data collection device 20, and a detection device of equipment abnormality 100 (also referred to herein as an equipment abnormality detection device 100).

The equipment 10 may be, for example, semiconductor equipment used in a semiconductor process or may be semiconductor equipment used in semiconductor testing. The semiconductor equipment is a plurality of types of equipment corresponding to a plurality of process steps, and each equipment may have various models that are upgraded depending on the timing. The semiconductor equipment may include, for example, dicing machines, probing machines, polish and edge grinders, chemical mechanical planarization (CMP) and photolithography equipment, etc. A plurality of sensors 15 for collecting operating status data may be attached to the equipment 10.

The data collection device 20 may collect input data, operating status data, and output data including equipment specifications for each of the various types of equipment 10. The data collection device 20 is connected to the plurality of sensors 15 and may collect operating status data from each sensor. For example, the operating status data may include equipment operating speed, temperatures inside and outside the equipment, atmospheric pressure, pressure, slope, current and voltage, vibration data, and the like.

The data collection device 20 may include a storage device 25. The data collection device 20 may classify the operating status data depending on various conditions such as, for example, each piece of equipment, each model of each piece of equipment, each predetermined period, each process, etc., and store the classified data in the storage device 25. The classified operating status data may be spatial data, time-series data, or attribute data. Although not illustrated, the data collection device 20 can include one or more of the following components: at least one central processing unit (CPU) configured to execute computer program instructions to perform various processes and methods, random access memory (RAM) and read only memory (ROM) configured to access and store data and information and computer program instructions, input/output (I/O) devices configured to provide input and/or output to the equipment abnormality detection device 100 (e.g., keyboard, mouse, display, speakers, printers, modems, network cards, etc.), and storage media or other suitable type of memory (e.g., such as, for example, RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives, any type of tangible and non-transitory storage medium) where data and/or instructions can be stored. In addition, the controller can include antennas, network interfaces that provide wireless and/or wire line digital and/or analog interface to one or more networks over one or more network connections (not shown), a power source that provides an appropriate alternating current (AC) or direct current (DC) to power one or more components of the controller, and a bus that allows communication among the various disclosed components of the controller.

According to some embodiments, the equipment abnormality detection device 100 may include a processor 110 and a memory 120. The processor 110 may execute instructions and computations for diagnosing the equipment status from the operating status data of the data collection device 20, and the memory 120 may store intermediate data and final data calculated on the basis of the operating status data. For example, memory 120 may store sensing values after data pre-processing, similarity between the sensors and correlation matrices, adjacent matrices, sensor networks, connection status difference values of sensor nodes, and diagnostic results associated with equipment abnormality.

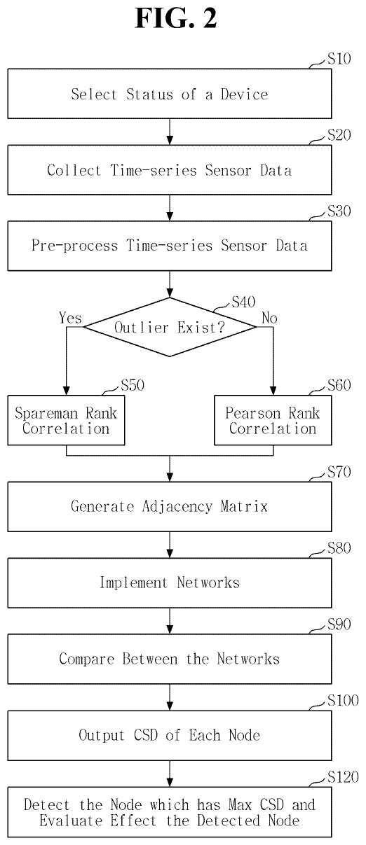

The equipment abnormality detection device 100 diagnoses the status of the equipment from the input data, operating status data, and output the data received from the data collection device 20 by the use of the processor 110, and detects whether or not there is an abnormality. The equipment abnormality detection device 100 may be, for example, a hardware device such as a mobile device, a general PC, a workstation, and a super computer for performing a diagnostic process on the basis of data. Hereinafter, the operation of the equipment abnormality diagnostic system 1 will be explained with reference to FIGS. 2 to 9.

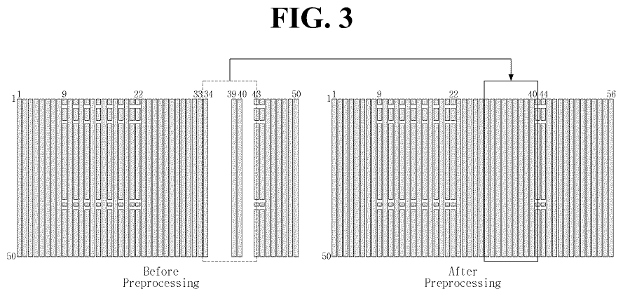

FIG. 2 is a flowchart for explaining an operating method of an equipment abnormality diagnostic system according to some example embodiments. Hereinafter, the operation for each step of the operating method of the equipment abnormality diagnostic system shown in FIG. 2 will be described with reference to FIGS. 3 to 9.

Referring to FIG. 2, the equipment abnormality diagnostic system 1, particularly the equipment abnormality detection device 100, first selects the status of the equipment to determine the range of data to be analyzed (S10). The status of the equipment may be determined on the basis of environmental information such as the equipment model name, specification information, usage period or usage space.

The status of the equipment 10 varies depending on the model or usage period. The equipment status is determined through the process results of the equipment, and for example, when the process result satisfies preset recommended standards, the equipment status is good and defined as a best of best (BOB) status. For example, when the process result meets the predetermined lower limit standard, the equipment status is good and defined as a best of best (BOB) status. However, when the process result of the equipment does not satisfy the predetermined lower limit standard, the equipment status is defined as a worst of worst (WOW) status. For example, when the process result of the equipment does not meet the predetermined lower limit standard, the equipment status is defined as a worst of worst (WOW) status. Alternatively, even in the case of the same equipment, in the same condition, the process results change depending on the period, and thus, may be defined as a period in which the equipment status is good (Best of Best (BOB) period) and a period in which the equipment status is bad (Worst of Worst (WOW) period).

The data collection device 20 or the equipment abnormality detection device 100 may select, for example, either BOB data or WOW data.

The data collection device 20 collects sensor data of the selected equipment status (S20). The sensor data collected by the data collection device 20 may be time-series data, which corresponds to a data collection period. For example, the equipment abnormality detection device 100 may notify the data collection device 20 of the selected equipment status. Alternatively, for example, the sensor data may be collected by selecting the status of the equipment within the data collection device 20.

A plurality of sensors are mounted on or attached to the equipment 10. The data collection device 20 receives and stores the data sensed from the plurality of sensors. For example, the data collection device 20 may map the sensed data to the equipment model name, data collection period, and product information and store the mapped data.

FIG. 3 is a diagram for explaining data changes for explaining a data pre-processing process of the equipment abnormality diagnostic system according to some example embodiments.

The equipment abnormality detection device 100 receives the sensed data from the data collection device 20, and preprocesses the received data (S30). The received data may be time-series data mapped to sensing timing within the data collection period. For example, when there is no sensing value of data at a specific time depending on the type of sensor (NA) or there is no change in the sensing value, the equipment abnormality detection device 100 may perform pre-processing for excluding the data of the sensor in which there is no sensing value or there is no change.

Referring to FIGS. 2 and 3, sensing data of the EUV equipment is shown as an example, a horizontal axis indicates time, and a vertical axis indicates sensing values. A case where there is a sensing value for a given sensor at that time is indicated by gray, and a case where there is no sensing value is indicated by white.

Raw data that has not been subjected to data pre-processing does not have a sensing value between sensing timings 34 to 39 and 40 to 43 of that sensor. The equipment abnormality detection device 100 removes the sensing data column of sensing timings 34 to 39 and 40 to 43 through the data pre-processing.

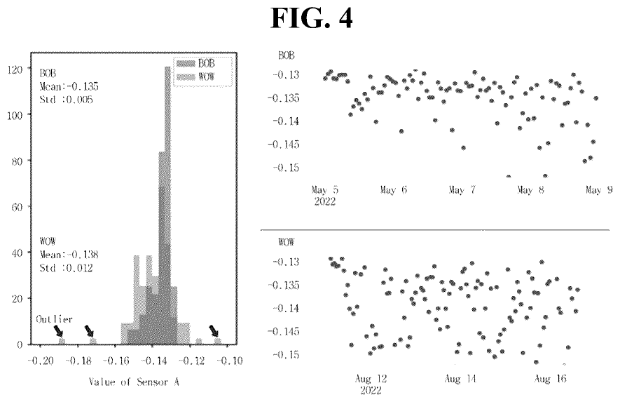

FIG. 4 is a histogram and a distribution graph for each time showing the distribution of sensor data.

The equipment abnormality detection device 100 checks whether an outlier exists in the pre-processed data (S40). According to some embodiments, the outlier may be determined as a case where the data does not satisfy predetermined criteria. For example, the outlier is determined on the basis of three-sigma rule, and a sensing value that does not belong to a range of 3 standard deviations among data may be determined as the outlier.

The equipment abnormality detection device 100 detects a degree of linear relationship between at least two sensors in the data after data pre-processing and calculates the similarity between the sensors.

For example, when the outlier exists in the pre-processed data (S40, Yes), the equipment abnormality detection device 100 calculates the similarity between sensors in a manner of a Spearman rank correlation coefficient (S50). The Spearman rank correlation coefficient manner expresses the similarity between sensors on a non-parametric scale that measures the statistical dependence between the ranks of at least two variables. The relationship between two variables will be explained through a monotonic function.

If there is no outlier in the pre-processed data (S40, No), the equipment abnormality detection device 100 calculates the similarity between the sensors in a manner of a Pearson correlation coefficient (S60). The Pearson correlation coefficient is a numerical value that quantifies the linear correlation between at least two variables and represents the similarity between sensors. The Pearson correlation coefficient is calculated as a value between −1 and 1, when it has a positive correlation coefficient, it is close to 1, and when it has a negative correlation coefficient, it is close to −1. The relationship between two variables will be explained through a linear function.

Referring to FIG. 4, a distribution of sensing values measured by sensor A of the extreme ultraviolet (EUV) equipment according to one embodiment is shown. The distribution of sensing values may vary depending on the selected equipment status. As an example, in a histogram on the left side of FIG. 4, a horizontal axis indicates the sensing value of sensor A, and a vertical axis indicates the number of sensing values. Referring to the histogram, the distribution of sensing values appears differently depending on whether the equipment status is a WOW status or a BOB status. For example, in the histogram, the distribution of sensing values of the BOB status shows an average value of −0.135 and a standard deviation of 0.005, but the distribution of sensing values of the WOW status shows an average value of −0.138, and a standard deviation of 0.012. However, as it may be understood from the histogram, the sensing values of the WOW status include outliers between −0.20 and −0.16 and between −0.12 and −0.10, respectively.

When the sensing values of the BOB status and WOW status, which are the basis of the histogram, are shown for each sensing timing as shown in the graph on the right, the sensing data of the BOB status is mainly distributed between −0.13 and −0.14 when there is no outlier, but the sensing data of the WOW status includes an outlier, and most of them are widely distributed between −0.15 and −0.13.

The distribution of the sensing values is checked to determine the existence of an outlier (S40), and for the sensing data of the BOB status, the similarity between the sensors is calculated in the manner of the Pearson correlation coefficient (S60). Since the sensing data of the WOW status includes the outlier, the similarity between the sensors is calculated in the manner of the Spearman Rank Correlation Coefficient (S50).

The equipment abnormality detection device 100 generates an adjacency matrix (S70). For example, the equipment abnormality detection device 100 generates an adjacency matrix on the basis of the calculated similarity between the sensors. If the adjacency matrix is an A×B matrix (A and B are natural numbers), the elements of the adjacency matrix are expressed as 1 when a of row A and b of column B are adjacent, and the elements are expressed as 0 when they are not adjacent. To explain more specifically, when the calculated similarity between row a of sensor A and column b of sensor B is equal to or greater than the reference threshold, Element Value (a, b)=1 is calculated, and when the calculated similarity between row a of sensor A and column b of sensor B is less than the reference threshold, Element Value (a, b)=0 is calculated. The reference threshold for determining the similarity may be adjusted by the user depending on the connection status of the sensor network.

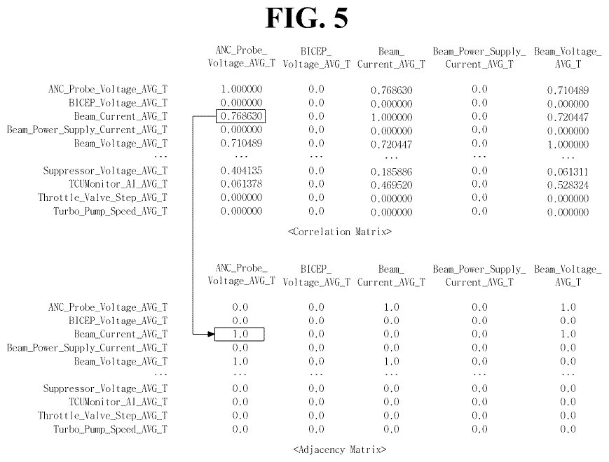

FIG. 5 is a diagram for explaining conversion of a correlation matrix into an adjacency matrix according to some example embodiments.

When the element values of the adjacency matrix are calculated for all the sensors attached to the equipment 10, the adjacency matrix is generated (S70). An embodiment will be described with reference to FIG. 5. The correlation matrix may be generated on the basis of the similarity between the sensors described in FIG. 4. The correlation matrix appears as a calculated similarity value between the sensors for each element of the matrix. For example, the similarity between a BEAM Current sensor and an ANC Probe Voltage sensor is 0.768630, and the similarity between a Suppressor Voltage sensor and an ANC Probe Voltage sensor is 0.404135.

The adjacency matrix is generated by converting the similarity for each element included in the correlation matrix into 1 or 0 on the basis of a reference threshold. When the reference threshold is set to 0.7 in the shown example, the similarity between the BEAM Current sensor and the ANC Probe Voltage sensor is converted into 1 since 0.768630 is equal to or greater than the reference threshold of 0.7. Since the similarity between the Suppressor Voltage sensor and the ANC Probe Voltage sensor is less than the reference threshold of 0.7, it is converted into 0. The similarity may be converted into 0 or 1 for other elements in the same manner.

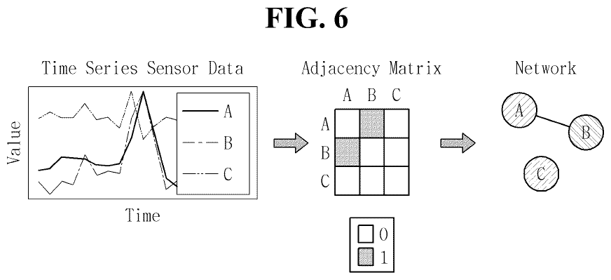

FIG. 6 is a conceptual diagram for explaining generating of sensing data of sensors A, B, and C into an adjacency matrix and sensor network according to some embodiments.

The equipment abnormality detection device 100 implements or sets up a sensor network on the basis of the adjacency matrix (S80).

Referring to FIG. 6, a sensor network between the plurality of sensors is implemented on the basis of element values of the adjacency matrix. In the shown example, it is assumed that there are a sensor A, a sensor B, and a sensor C that have time-series data. The data of sensors A, B and C may be indicated by an adjacency matrix as shown, on the basis of the similarity between two sensors.

For example, sensor A and sensor B have similar changes in sensing values over time. In this case, the similarity is determined to be equal to or greater than the reference threshold point, and the element value of the adjacency matrix may become 1. However, sensor A and sensor C have almost no similar changes in sensing values over time. Furthermore, sensor B and sensor C have less similar changes in sensing values over time. In this case, the similarity between sensors A and C and the similarity between sensors B and C are determined to be below the reference threshold point, and the element value of the adjacency matrix may become 0.

The equipment abnormality detection device 100 implements a sensor network by connecting the association status between the sensors with lines. That is, the equipment abnormality detection device 100 implements a sensor network such that the association status is connected by a line (Edge) between the sensors when the element value of the adjacency matrix is 1, and the line is not drawn when the element value is 0. In the shown example, depending on the adjacency matrix, the nodes of sensors A-B are connected by lines, but the nodes of sensors A-C or B-C are only independent, and the lines are not connected.

For example, the equipment abnormality detection device 100 may implement a sensor network for the plurality of sensors attached to the equipment 10 on the basis of an adjacency matrix according to the similarity of sensing values, in the manner such as the shown example.

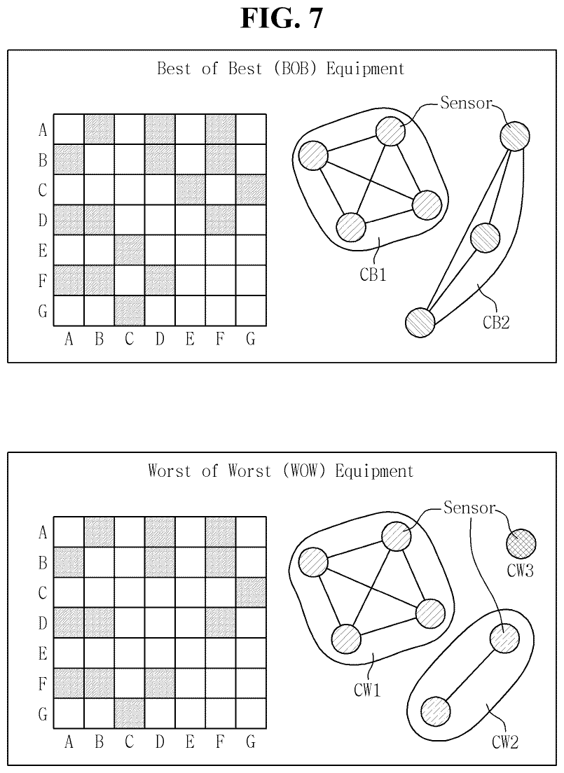

FIG. 7 is a conceptual diagram for explaining a sensor network between seven sensors according to some example embodiments.

The equipment abnormality detection device 100 compares the implemented sensor networks (S90).

Referring to FIG. 7, it is assumed that there are seven sensors according to some embodiments. The similarity between the seven sensors may be expressed as the adjacency matrix on the left. The equipment abnormality detection device 100 implements a sensor network such that lines are connected for black and are not connected for white, depending on whether the color of each cell in the left adjacency matrix is black (matrix element value=1) or white (matrix element value=0).

When implementing the sensor network of the BOB status and WOW status, in the sensor network of the BOB status, four sensors are connected to each other to form a CB1 group, and three sensors form a CB2 group. In a sensor network of the WOW status, four sensors are connected to each other to form a CW1 group, two sensors form a CW2 group, and one sensor CW3 exists independently.

When comparing the sensor networks of the BOB status and the WOW status, it is checked that the CB1 group and the CW1 group have the same sensor network connections, but there is a difference in connection between the CB2 group and the CW2 and CW3 groups. The equipment abnormality detection device 100 may compare the BOB status sensor network and the WOW status sensor network to check sensors with group differences and connection status changes.

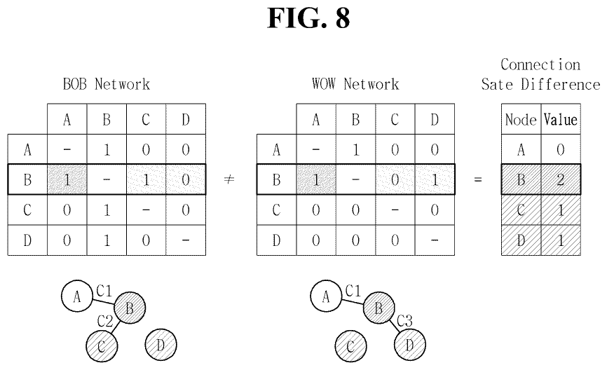

FIG. 8 is a diagram for explaining differences in connection statuses for each node of the sensor network according to some example embodiments.

The equipment abnormality detection device 100 calculates a connection status difference (CSD) value of each node in the sensor network (S100).

By comparing sensor networks that vary depending on the status of the equipment, it is possible to calculate the difference value of the connection status. The same sensor is selected in two sensor networks according to the equipment status, and the connection statuses of other sensors connected to the selected sensor in the sensor network of each state are compared.

For example, the sensor A is selected, and the status of other sensors connected to the sensor A in the first sensor network by a line is compared with the status of other sensors connected to the sensor A in the second sensor network by a line.

Referring to FIG. 8, if the element values between the adjacency matrix of the BOB status and the adjacency matrix of the WOW status are equal, CSD=0 is calculated, and if the element values are different, CSD=1 is calculated, according to some embodiments. The total CSD value may be calculated according to the adjacency matrix element values with other sensors for each sensor. In the shown example, if the sensor B is selected and examined, the sensor B is connected to the sensor A and the sensor C by lines C1 and C2 in the BOB sensor network, but is connected to the sensor A and the sensor D by lines C1 and C3 in the WOW sensor network. Also when examining at the adjacency matrix, the element value of the second row corresponding to the sensor B is (1,−,1,0) in the BOB sensor network, and is (1,−,0,1) in the WOW sensor network. Accordingly, there is a difference in the element value.

For example, since a difference occurs between Adjacency Matrix (2, 3) of the second row, third column, and Adjacency Matrix (2, 4) of the second row, fourth column, the equipment abnormality detection device 100 may calculate CSD=2.

In the case of the sensor C, since there is a difference only in the adjacency matrix (3, 2), CSD=1 may be calculated, and in the case of the sensor D, since there is a difference only in the adjacency matrix (4, 2), CSD=1 may be calculated.

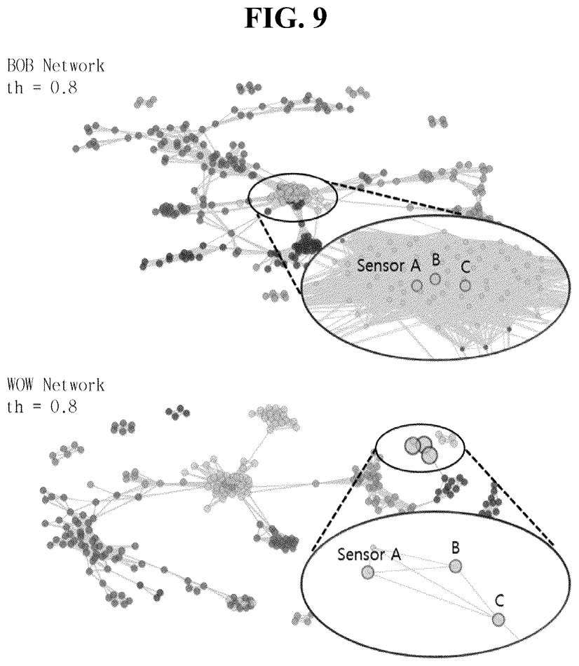

FIG. 9 is a diagram showing the influence of nodes with maximum connection status difference in the sensor network according to some example embodiments.

The equipment abnormality detection device 100 detects a node having the maximum CSD value as a result of comparison of two sensor networks with different equipment statuses, and evaluates the influence of the detected node (S120).

Referring to FIG. 9, when a WOW status sensor network and a BOB status sensor network are shown for the plurality of sensors, the connection statuses of the lines are different from each other, and the BOB status network is more densely connected with lines than the WOW status network.

Looking more closely at the sensor network of sensors A, B, and C calculated in FIG. 8, it is possible to understand that sensors A, B, and C are closely connected to other sensors in the BOB sensor network, whereas sensors A, B, and C are disconnected from most other sensors in the WOW sensor network. For example, it is possible to detect a sensor that behaves specifically in the WOW status.

For example, since the connection is sparse on the basis of the sensor B, the hardware parts associated with the sensor B are checked, and it is possible to manage the equipment status, and analyze the usage history. Accordingly, it is possible to diagnose whether there is an abnormality in the equipment and to detect the equipment part that becomes the cause of the abnormality.

The equipment abnormality diagnostic system 1 may calculate the similarity between the sensors according to the equipment status on the basis of the data of the equipment 10, visualize the sensor network based on the similarity between the sensors, and visually detect the connection status difference between the nodes for each sensor.

By visually checking the connection status differences between the sensor nodes for each equipment status, the equipment abnormality diagnostic system 1 is able to discover sensor nodes that are problematic in operation, and more easily detect the discovered sensor node and the sensor node with possibility of abnormality associated therewith. The equipment abnormality diagnostic system 1 may check a part of the equipment associated with the detected sensor nodes and diagnose the presence or absence of an abnormality and the degree of failure.

In concluding the detailed description, those skilled in the art will appreciate that many variations and modifications may be made to the preferred embodiments without substantially departing from the principles of the present disclosure. Therefore, the disclosed preferred embodiments of the disclosure are used in a generic and descriptive sense only and not for purposes of limitation.

What is claimed is:

1. An equipment abnormality diagnostic system comprising:
a data collection device configured to collect operating status data from a plurality of sensors attached to equipment; and
an equipment abnormality detection device configured to diagnose whether the equipment is abnormal on the basis of the operating status data,
wherein the equipment abnormality detection device is configured to:
select equipment statuses from the collected operating status data,
calculate a similarity between the plurality of sensors from filtered sensor data of the selected equipment statuses,
implement a sensor network on the basis of the similarity between the plurality of sensors,
compare the sensor network of a first equipment status of the selected equipment statuses with the sensor network of a second equipment status of the selected equipment statuses to compare connection statuses for each sensor node, and
check an influence of a sensor node having a maximum connection status difference value as a comparison result to diagnose an abnormality status of the equipment.

2. The equipment abnormality diagnostic system of claim 1, wherein the filtered sensor data is data obtained by:
extracting operating status data corresponding to the selected equipment statuses among the collected operating status data, and
data pre-processing by excluding an operating status for which no sensing value exists from the extracted operating status data.

3. The equipment abnormality diagnostic system of claim 1, wherein the calculating of the similarity between the sensors includes:
checking whether an outlier is included in the filtered sensor data, and
calculating similarity between the sensors according to a degree of linear relationship between at least two sensors to generate a correlation matrix.

4. The equipment abnormality diagnostic system of claim 3, wherein the calculating of the similarity between the sensors according to the degree of linear relationship includes:
calculating the similarity between the sensors through a linear function manner, when the filtered sensor data does not include the outlier, and
calculating the similarity between the sensors through a monotonic function manner, when the filtered sensor data includes the outlier.

5. The equipment abnormality diagnostic system of claim 1,
wherein the equipment status is status information that is determined on the basis of environmental information including a model name, specification information, usage period, or usage space of the equipment.

6. The equipment abnormality diagnostic system of claim 1, wherein the implementing of the sensor network includes:
comparing the similarity between the sensors with a reference threshold to generate an adjacency matrix, and
realizing the sensor network in which association statuses for each sensor with other sensors are connected by lines on the basis of the adjacency matrix.

7. The equipment abnormality diagnostic system of claim 6, wherein the comparing of the connection statuses includes:
comparing a first connection status between sensor nodes in the sensor network of the first equipment status with a second connection status between sensor nodes in the sensor network of the second equipment status,
detecting sensor nodes in which connection statuses differ, and
calculating connection status difference values of the detected sensor nodes.

8. The equipment abnormality diagnostic system of claim 7, wherein the diagnosing of the abnormality status includes:
detecting a sensor node having the maximum connection status difference value among the calculated connection status difference values,
diagnosing a part of the equipment associated with the detected sensor node and other sensor nodes connected to the detected sensor node, and
diagnosing an abnormality status of the equipment.

9. An equipment abnormality diagnostic system comprising:
a data collection device configured to collect operating status data from a plurality of sensors attached to equipment; and
an equipment abnormality detection device configured to diagnose whether the equipment is abnormal on the basis of the operating status data,
wherein the equipment abnormality detection device configured to:
pre-process the collected operating status data,
filter the pre-processed operating status data for each equipment status,
calculate a similarity between at least two sensors from the filtered operating status data,
implement a sensor network on the plurality of sensors on the basis of the similarity,
compare connection statuses between sensor networks corresponding to at least two equipment statuses, and
diagnose an abnormality status of the equipment on the basis of the sensor networks having different connection statuses.

10. The equipment abnormality diagnostic system of claim 9,
wherein the operating status data is time-series data that is classified and stored depending on conditions of the equipment for each model, period, and process.

11. The equipment abnormality diagnostic system of claim 9,
wherein the equipment status is status information that is determined on the basis of environmental information including a model name, specification information, usage period, or usage space of the equipment.

12. The equipment abnormality diagnostic system of claim 9,
wherein the data pre-processing excludes operating status data of a sensor that has no sensing value or no variation in sensing value.

13. The equipment abnormality diagnostic system of claim 9, wherein the calculating of the similarity between the sensors includes:
checking whether the filtered operating status data includes an outlier, and
calculating similarity between the sensors according to a degree of linear relationship between at least two sensors to generate a correlation matrix.

14. The equipment abnormality diagnostic system of claim 13, wherein the calculating of the similarity between the sensors according to a degree of linear relationship includes:
calculating the similarity between the sensors through a Pearson correlation coefficient manner, when the filtered operating status data does not include the outlier, and
calculating the similarity between the sensors through a Spearman correlation coefficient manner, when the filtered operating status data includes the outlier.

15. The equipment abnormality diagnostic system of claim 13,
wherein the outlier is a sensing value determined on the basis of a three-sigma rule in the filtered operating status data.

16. The equipment abnormality diagnostic system of claim 9, wherein the implementing of the sensor network includes:
generating a comparison result of the similarity between the sensors with a reference threshold as an adjacency matrix, and
visualizing a relationship for each sensor with lines on the basis of the adjacency matrix to realize the sensor network.

17. The equipment abnormality diagnostic system of claim 16, wherein the comparing of the connection status includes:
comparing a first connection status of the sensor network of a first equipment status with a second connection status of the sensor network of a second equipment status,
detecting sensor nodes in which connection statuses differ, and
calculating a connection status difference value of the detected sensor nodes.

18. The equipment abnormality diagnostic system of claim 17, wherein the diagnosing of the abnormality status includes:
detecting a sensor node having the maximum connection status difference value among the calculated connection status difference values,
diagnosing a part of the equipment associated with the detected sensor node and other sensor nodes connected to the detected sensor node, and
diagnosing an abnormality status of the equipment.

19. An equipment abnormality diagnostic system comprising:
a data collection device configured to collect operating status data from a plurality of sensors attached to equipment; and
an equipment abnormality detection device comprises a memory configured to store operating status data and a processor configured to detect an abnormality status of the equipment on the basis of the operating status data,
wherein the processor is further configured to:
receive the operating status data from a plurality of sensors attached to the equipment,
select an equipment status of the equipment,
calculate similarity between at least two sensors from the operating status data for each equipment status,
implement a sensor network for each equipment status on the basis of the similarity between the sensors,
compare the sensor network of a first equipment status with the sensor network of a second equipment status to compare a connection status for each sensor node, and
check a sensor node having a maximum connection status difference value as a comparison result to diagnose an abnormality status of the equipment.

20. The equipment abnormality diagnostic system of claim 19, wherein the implementing of the sensor network includes:
visualizing a relationship between the sensors with lines on the basis of the similarity between the sensors to express the sensor network.
